(19) United States
(12) Patent Application Publication
(10) Pub. No.: US 2018/0074659 A1
(43) Pub. Date: Mar. 15, 2018

(54) APPLICATION USER INTERFACE DESIGN TOOL

(71) Applicant: CERNER INNOVATION, INC., KANSAS CITY, KS (US)

(72) Inventors: MATT RYAN ANDERSON, KANSAS CITY, MO (US); MATTHEW JOSEPH HENKES, LEE'S SUMMIT, MO (US); TYLER ALEXANDER BIETHMAN, LEE'S SUMMIT, MO (US)

(21) Appl. No.: 15/262,702

(22) Filed: Sep. 12, 2016

(51) Int. Cl. G06F 3/0482; G06F 3/0481; G06F 3/0486

(52) U.S. Cl. CPC G06F 3/0482; G06F 3/0486; G06F 3/04817

(57) ABSTRACT

Systems and methods provide for a design tool that facilitates the design of user interfaces for applications. The design tool provides a workspace for building a user interface from pre-defined user interface elements. Each user interface element has corresponding code for rendering visible features. When user interface elements are added to the workspace, visible features for the user interface elements are presented in the workspace and base user interface code is generated from the corresponding code for the added user interface elements. Additionally, configurable features for the selected user interface elements are presented, allowing for adjustment of the configurable features, which results in updates to the visible features in the workspace and the base user interface code. The design tool outputs the base user interface code, which can be used by a developer to generate code for the application being developed.

### BACKGROUND

Developing software applications for a company can be a time-consuming task involving multiple parties. Typically, a user experience (UX) designer or a team of UX designers is responsible for the visual design of an application, including aspects of the application's user interfaces, such as the content and styling used. A developer or a team of developers is responsible for taking the visual design created by the UX designer(s) and writing code to produce an application with that visual design. Often, this requires a back and forth between the UX designer(s) and developer(s) to get the visual design correct, which can be tedious and time-consuming.

The design of applications is further complicated when a company has numerous applications. When a company's applications are developed by different teams of UX designers and developers, it can be difficult to have consistency across the applications. For instance, different UX designers could produce applications having user interfaces with a different look and feel. As a result, users don't have a consistent experience across the company's applications. Additionally, different developers may be using different programming languages to develop the various applications. Among other things, this makes it hard to maintain the company's various applications.

### SUMMARY

Embodiments of the present invention relate to, among other things, a design tool that facilitates the design of user interfaces for applications. The design tool provides a number of pre-defined user interface elements. Each user interface element has corresponding code for rendering visible user interface features. Additionally, each user interface element may include one or more configurable features that can be adjusted by the UX designer. To build a user interface, the design tool provides a workspace, and the UX designer can select and add user interface elements to the workspace. When a user interface element is selected and added to the workspace, visible features are presented in the workspace, and base user interface code is generated from underlying code for the selected user interface element. Additionally, configurable features for the selected user interface element are presented adjacent to the workspace. If the UX designer adjusts the configurable features, the visible features in the workspace and the base user interface code are updated. The output from the design tool is the base user interface code that was generated from the underlying code for selected user interface elements adjusted based on the UX designer's input to the configurable features for each selected user interface element. The base user interface code can be provided to a developer for use in generating code for an application being developed.

Accordingly, in one aspect, an embodiment of the present invention is directed to one or more computer storage media storing computer-useable instructions that, when executed by a computing device, cause the computing device to perform operations. The operations include presenting a workspace for designing a user interface for an application. The operations also include providing a plurality of user interface elements, each user interface element comprising one or more visible features and one or more configurable features, each user interface element having corresponding code for rendering the one or more visible features based at least in part on the one or more configurable features. The operations further include receiving a selection of a first user interface element, presenting the one or more visible features of the first user interface element in the workspace, and generating base user interface code from the corresponding code for the first user interface element. The operations also include presenting the one or more configurable features for the first user interface element in an area adjacent to the workspace. In response to receiving user input for the one or more configurable features for the first user interface element, the operations include updating the one or more visible features of the first user interface element in the workspace and updating the base user interface code. The operations still further include outputting the base user interface code for use in development of the application.

In another embodiment, an aspect is directed to a computer-implemented method for generating a user interface for an application. The method includes presenting a workspace for designing the user interface for the application. The method also includes providing a plurality of user interface elements, each user interface element comprising one or more visible features and one or more configurable features, each user interface element having corresponding code for rendering the one or more visible features based at least in part on the one or more configurable features. The method further includes receiving a selection of a first user interface element, presenting the one or more visible features of the first user interface element in the workspace, and generating base user interface code from the corresponding code for the first user interface element. The method also includes presenting the one or more configurable features for the first user interface element in an area adjacent to the workspace. In response to receiving user input for the one or more configurable features for the first user interface element, the method includes updating the one or more visible features of the first user interface element in the workspace and updating the base user interface code. The method still further includes outputting the base user interface code for use in development of the application.

A further embodiment is directed to a computer system comprising: one or more processors; and one or more computer storage media storing computer-useable instructions that, when used by the one or more processors, cause the one or more processors to: present a workspace for designing a user interface for an application; provide a plurality of user interface elements, each user interface element comprising one or more visible features and one or more configurable features, each user interface element having corresponding code for rendering the one or more visible features based at least in part on the one or more configurable features; receive a selection of a first user interface element; present the one or more visible features of the first user interface element in the workspace; generate base user interface code from the corresponding code for the first user interface element; present the one or more configurable features for the first user interface element in an area adjacent to the workspace; in response to receiving user input for the one or more configurable features for the first user interface element, update the one or more visible features of the first user interface element in the workspace and update the base user interface code; and output the base user interface code for use in development of the application.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIGS. 1A-1J are screenshots illustrating a UX design tool being used to design a user interface and generate base user interface code for the user interface;

FIG. 2 is a block diagram illustrating an exemplary system in accordance with some implementations of the present disclosure;

FIG. 3 is a flow diagram showing a method for generating base user interface code that can be used in developing an application in accordance with some implementations of the present disclosure;

FIG. 4 is a screenshot providing an example of an output of software requirements generated in accordance with some implementations of the present disclosure;

FIG. 5 is a screenshot providing an example of document patterns that are referenced as source material for technical documentation in accordance with some implementations of the present disclosure; and

FIG. 6 is a block diagram of an exemplary computing environment suitable for use in implementations of the present disclosure.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide a design tool that facilitates the design of user interfaces for applications for a company. The design tool employs a modular approach providing a number of pre-defined user interface elements that can be used to build a user interface for an application. Each user interface element has underlying code for rendering portions of a user interface. As such, each user interface element provides a model representation of layout and style with limited options for modifying features of the user interface element. The user interface elements are modular and can be nested within one another to build a user interface. The output from the design tool is base user interface code, which is provided to a developer to include in an application being developed. As such, the output from the design tool is not the application itself, but a code portion for the user interface that can be employed by the application developer when generating the code for the application.

The design tool provides a workspace for generating a user interface using the pre-defined user interface elements. Using the design tool, a UX designer selects user interface elements to add to the workspace. When a user interface element is added to the workspace, visible features from the user interface element are displayed within the workspace. Additionally, the underlying code from the added user interface element is added to the base user interface code for the user interface being designed. Each user interface element may have a limited number of configurable features that can be adjusted by the UX designer. When a user interface element is added to the workspace, the design tool displays a details area that exposes the configurable features to the UX designer. The UX designer can then adjust the configurable features for that user interface element, and the base user interface code for the user interface being designed is updated.

The design tool discussed herein provides a number of advantages. Because the output from the design tool is actual code that can be used by an application developer, the design tool substantially reduces or eliminates the back and forth between the UX designer and developer when developing an application. Additionally, because the user interface elements are pre-defined with limited features that can be configured, the design tool enforces consistency across user interfaces for applications of a company. UX developers are forced to employ user interface patterns that have been approved for the company to make applications consistent. This enforces certain patterns in building applications instead of allowing applications to be developed using a blank canvas. Additionally, the design tool forces UX designers to use tools that are also available to developers so the UX designers are able to build user interfaces that can be readily deployed within developers' applications. Further, because the design tool outputs actual code that can be used to render user interfaces, the design tool can be used for prototyping, allowing user interfaces to be generated and tested on the fly, such as on customer premises when developing applications for customer use.

In some instances, the underlying code for each user interface element includes code for adjusting the layout of the user interface to different screen sizes. As such, user interfaces designed using the design tool described herein can automatically adjust to the screen size of a device on which it is rendered. Additionally, in some instances, different versions of the underlying code can be provided for each user interface element using different programming languages. This allows the user interface code to be built in any of the available programming languages.

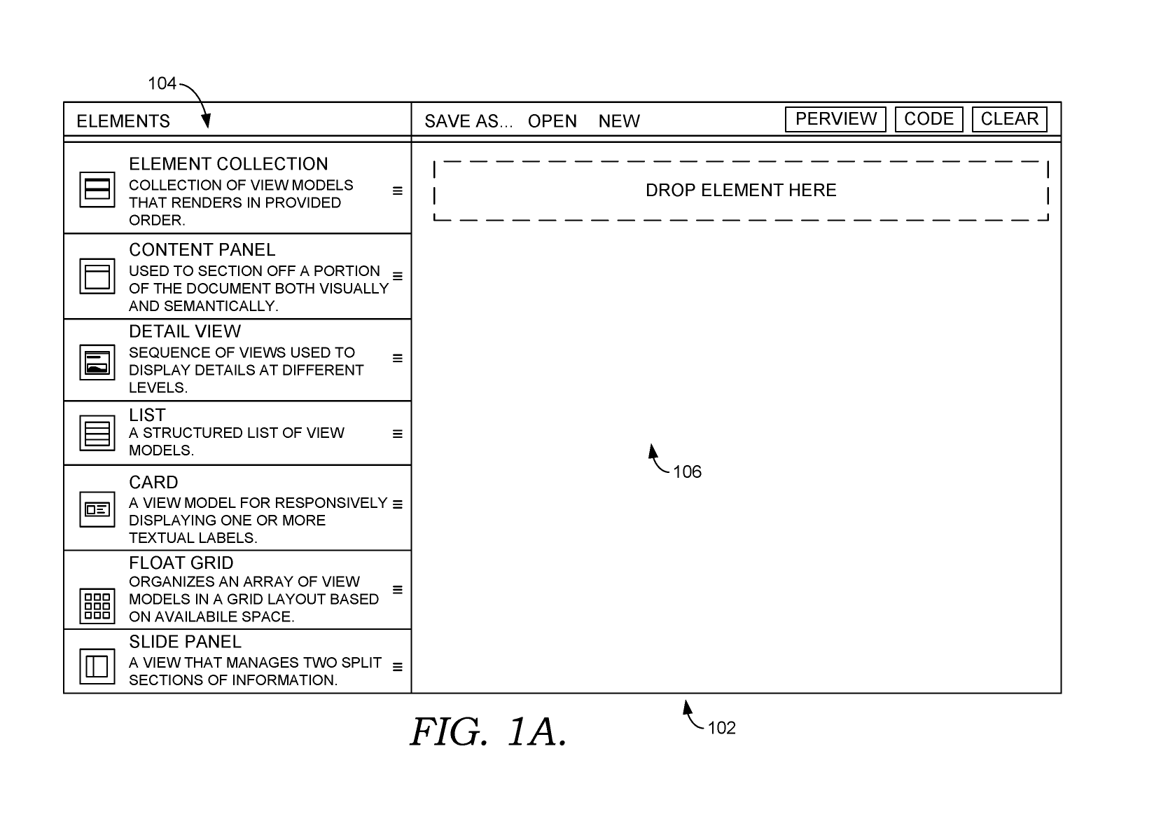

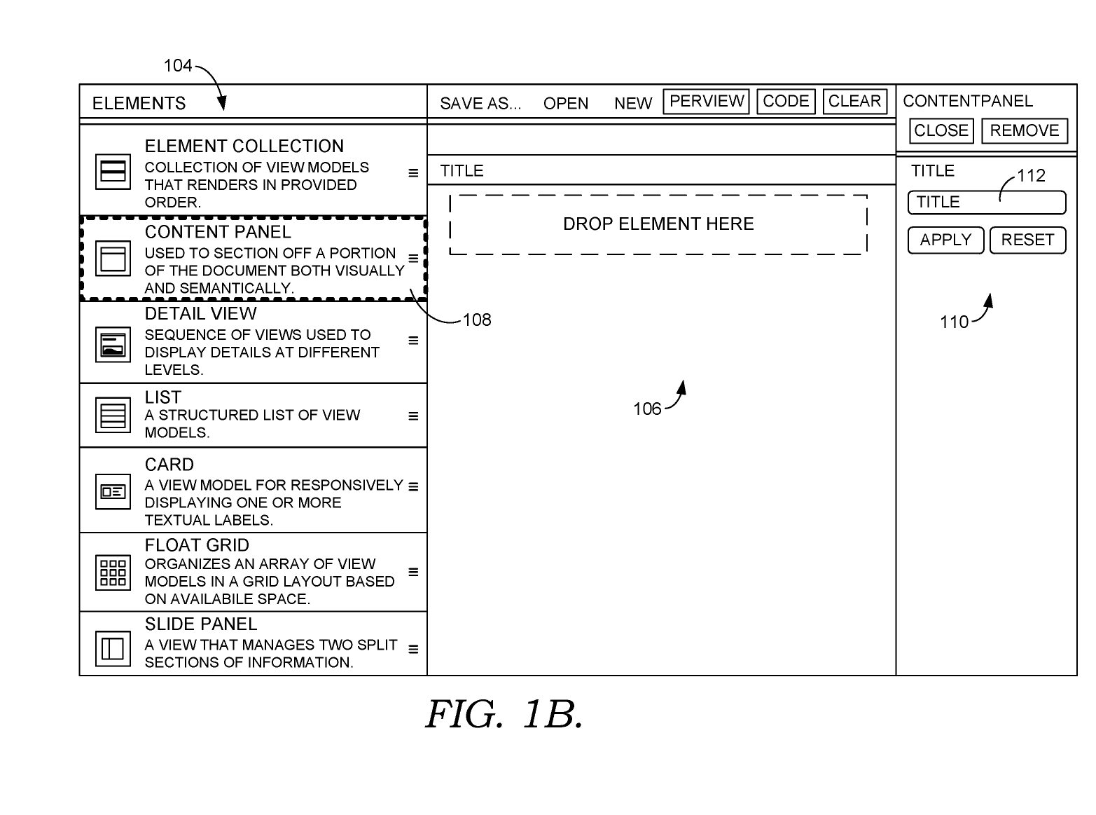

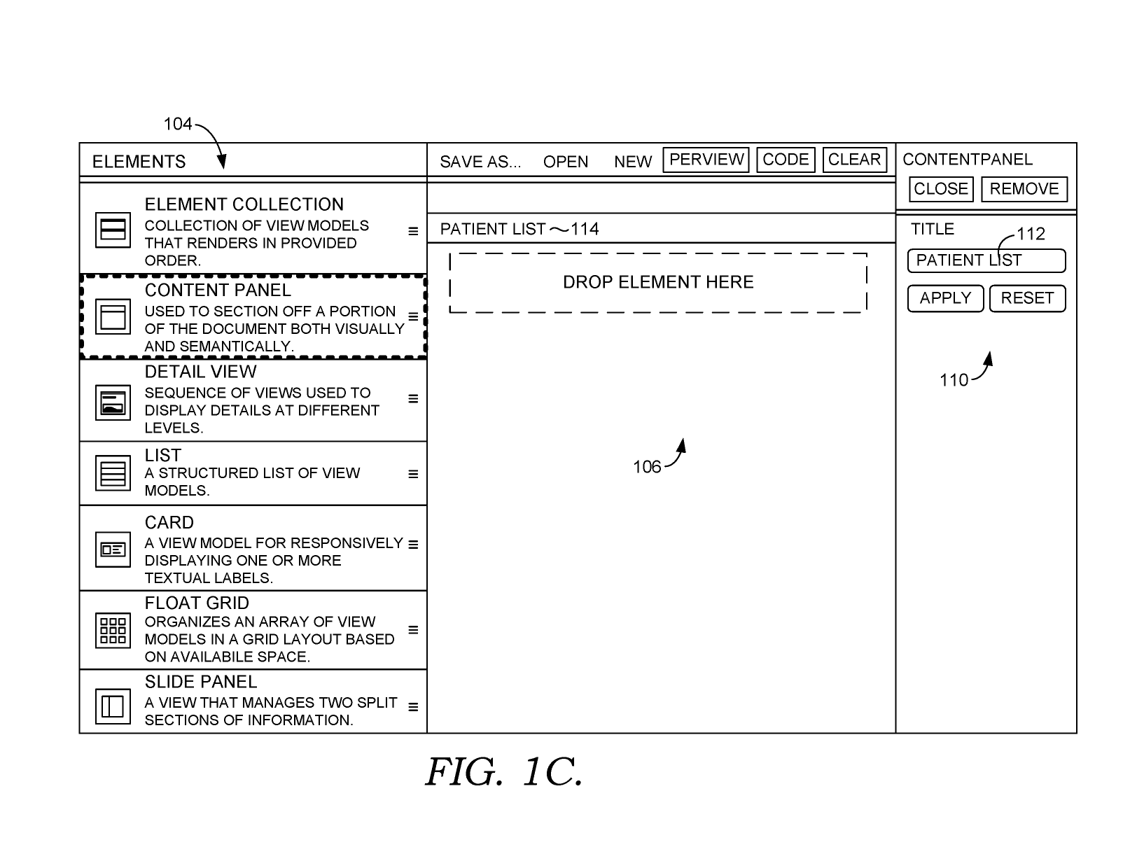

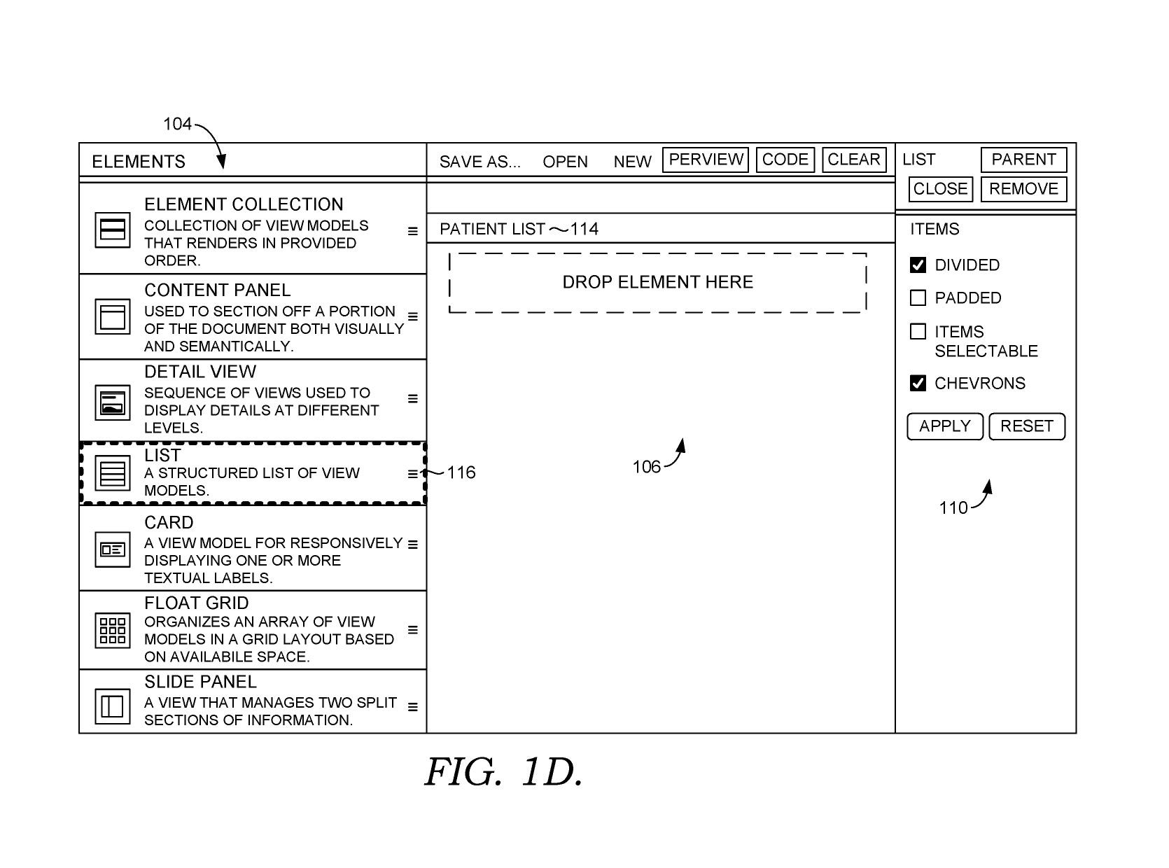

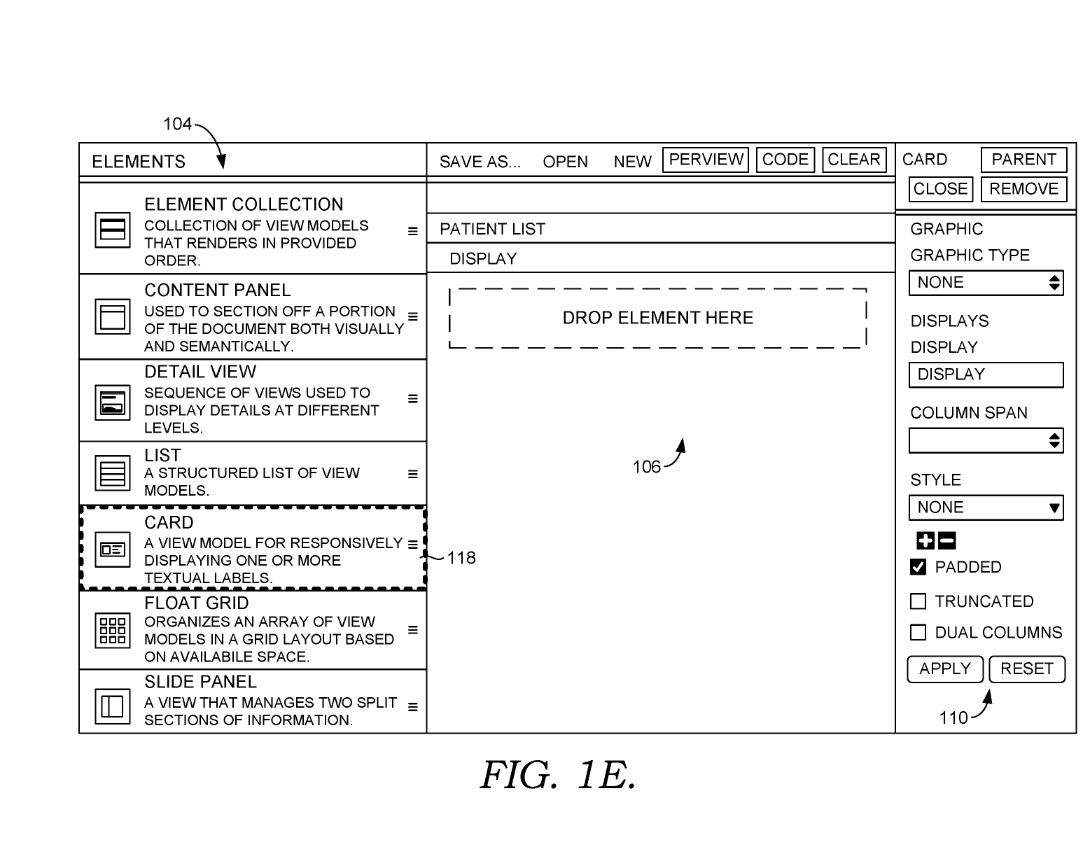

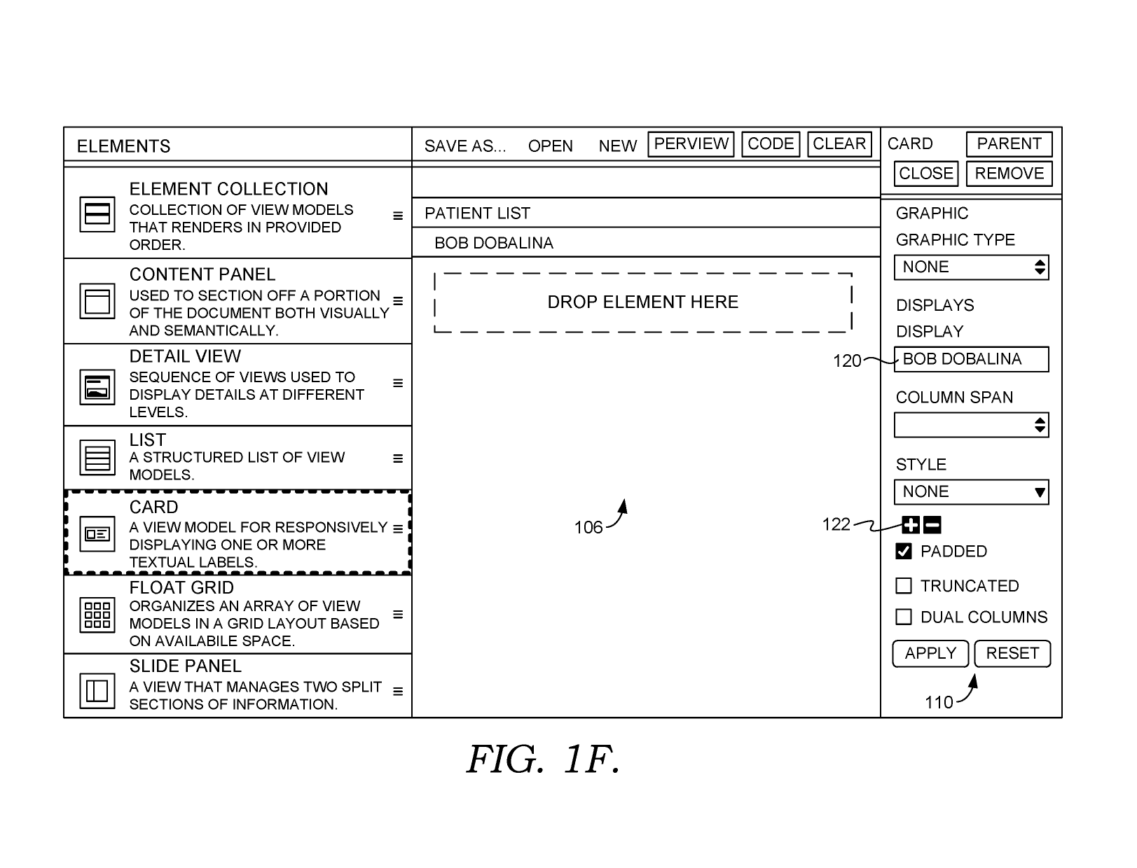

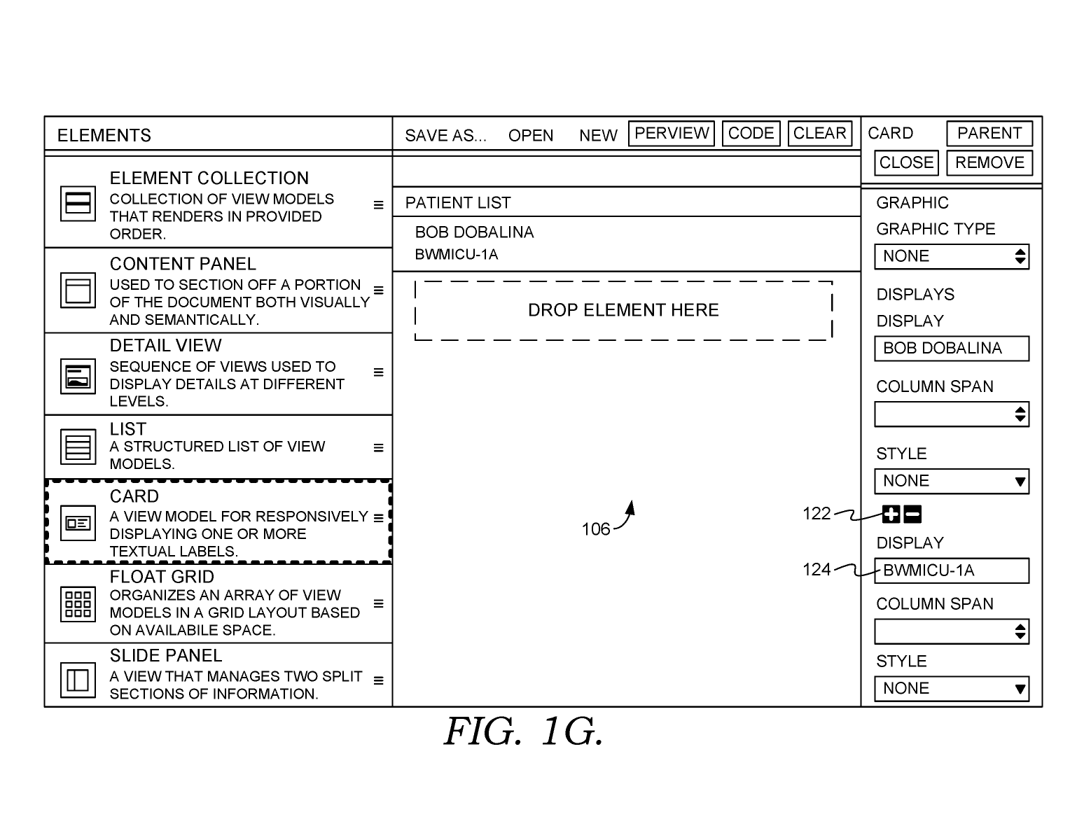

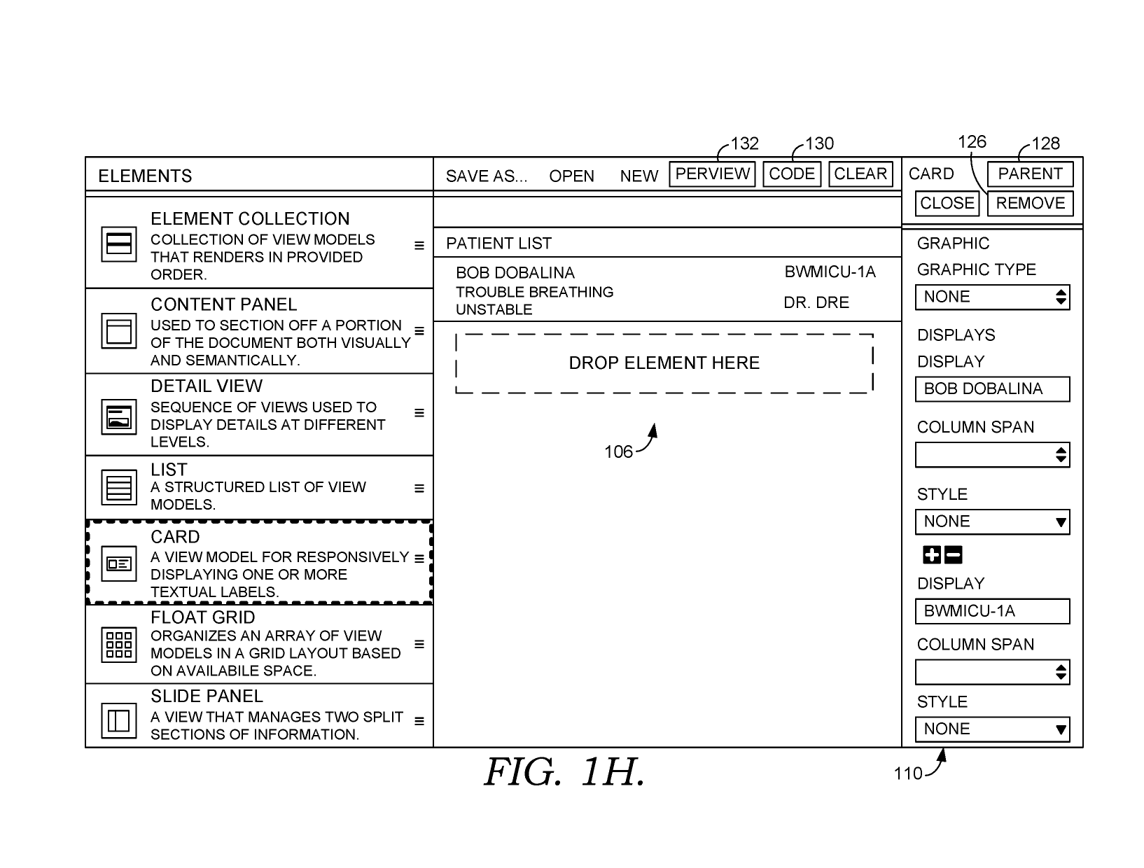

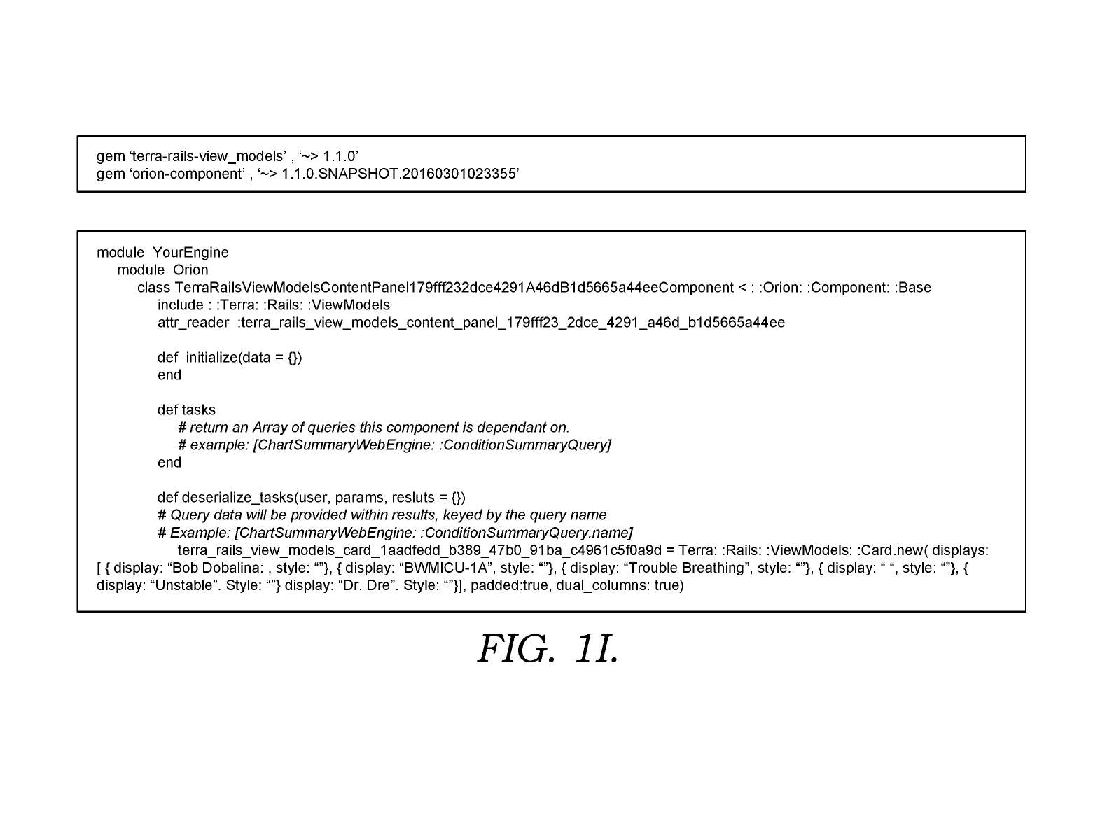

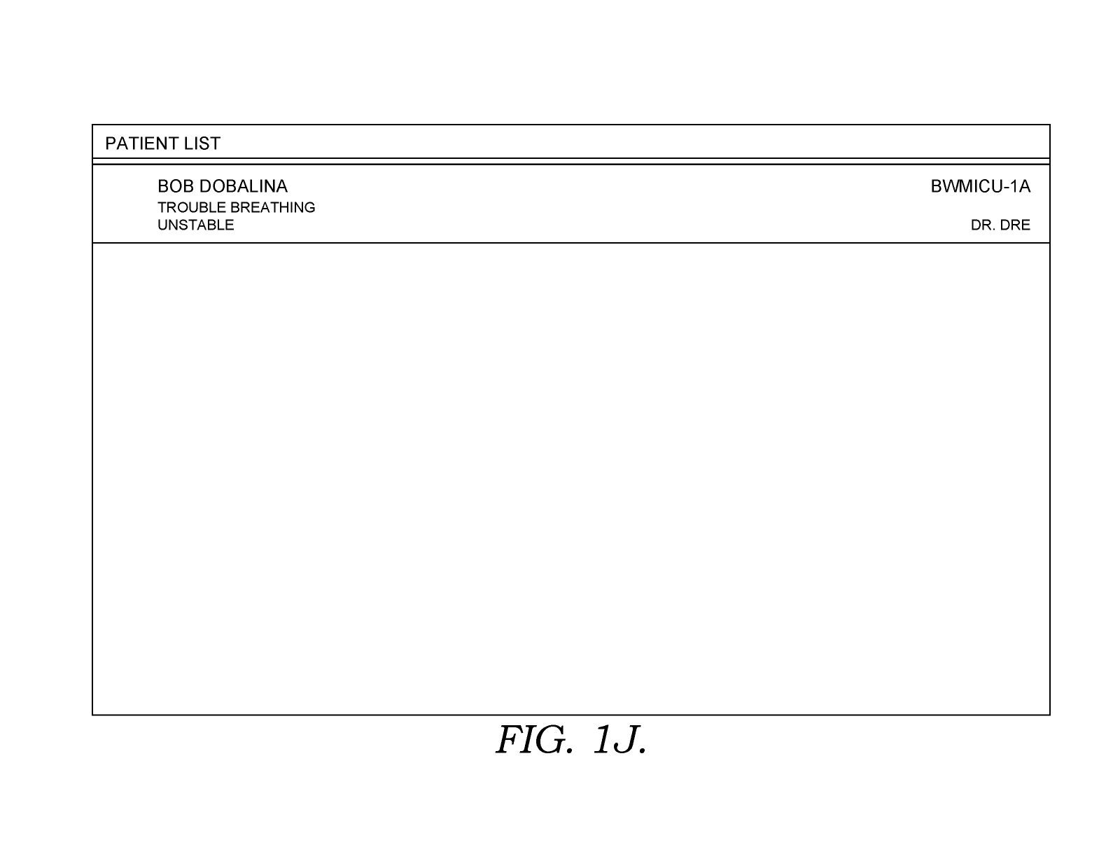

By way of example to illustrate, FIGS. 1A-1J are screenshots showing use of a UX design tool to generate base user interface code in accordance with an embodiment of the present invention. In particular, the screenshots of FIGS. 1A-1J provide an example in which a user interface is designed for a patient list. Referring initially to FIG. 1A, an illustrative screen display is provided showing a UX design user interface 102 for generating base user interface code in accordance with an embodiment of the present invention. The UX design user interface 102 includes a user interface element area 104 and a workspace 106.

The user interface element area 104 provides a number of pre-defined user interface elements. Each user interface element has corresponding code for rending visible features for the user interface element. Additionally, each user interface element has configurable features that can be adjusted by the UX designer. In accordance with embodiments herein, the user interface elements are pre-defined with certain visible features and limited configuration features to enforce consistency among user interfaces developed for applications using the design tool.

The workspace 106 generally provides an area for building a user interface using user interface elements from the user interface element area 104. The UX designer can add a user interface element to the user interface being built by selecting one of the user interface elements from the user interface element area 104 and placing the selected user interface element in the workspace 106. For instance, a user can use a pointing device to drag a user interface element from the user interface element area 104 and drop the user interface element in the workspace 106. When a UX designer adds a user interface element to the workspace 106, the code associated with that user interface element is added to the base user interface code being built by the design tool.

By way of example to illustrate, FIG. 1B illustrates a UX designer selecting a content panel user interface element 108 from the user interface element area 104 and dropping it in the workspace 106. Accordingly, the code associated with the content panel user interface element 108 is added to the base user interface code being built in this example.

Additionally, when a user interface element is added to the workspace 106, a details area 110 is provided that exposes the configurable features for that user interface element. As noted above, the configurable features can be limited to enforce consistency among user interface designs. For instance, FIG. 1B shows a details area 110 that is presented in response to the UX designer adding the content panel user interface element 108 to the workspace 106. As shown in FIG. 1B, the details area 110 for the content panel user interface element 108 includes a text box 112 for entering a title. As shown in FIG. 1C, when the UX designer adds text to the text box 112, the title 114 in the workspace 106 is updated. Additionally, the base user interface code is updated based on the selection made in the details area 110.

The UX designer can continue the design of the user interface by adding additional user interface elements to the workspace 106. By way of example, FIG. 1D illustrates the UX designer selecting a list user interface element 116 from the user interface element area 104 and placing it in the workspace 106. When the list user interface element 116 is added to the workspace 106, the base user interface code being built is modified by the code associated with the list user interface element 116.

Additionally, as shown in FIG. 1D, when the list user interface element 116 is added to the workspace 106, the details area 110 is updated to provide the configurable features for the list user interface element 116. The UX designer can select desired options for the configurable features which are then applied to the workspace 106 and the base user interface code is updated accordingly.

In FIG. 1E, the UX designer continues building the user interface by selecting a card user interface element 118 from the user interface element area 104 and adding it to the workspace 106. When the card user interface element 118 is added to the workspace 106, the workspace 106 is updated to reflect the card user interface element, and the base user interface code is updated to include the code corresponding to that user interface element. Additionally, the details area 110 is updated to reflect configurable features for the card user interface element 118. The card user element 118 allows for the addition of one or more textual display labels. As shown in FIG. 1F, the UX designer adds an example patient name in the display text box 120, and the example patient name is displayed in the workspace 106. As also shown in FIG. 1F, the details area 110 also includes options for adjusting the column span and style for the display.

The UX designer can add additional textual display labels by selecting a ‘+’ icon 122 in the details area 110. For instance, in FIG. 1G, the UX designer has selected the ‘+’ icon 122 and configurable features for another textual display label are provided, including another display text box 124 in which the UX designer has entered an example treatment location, which is displayed in the workspace 106. In this manner, the UX designer can add various displays labels to the card in the workspace 106. For instance, in FIG. 1H, the UX designer has also entered example patient conditions, “Trouble Breathing” and “Unstable,” and an example clinician name “Dr. Dre,” which are displayed in the workspace 106. Additionally, the UX designer has selected an option to display the labels in dual columns.

The details area 110 includes a “Remove” button 126 that allows the UX designer to remove a user interface element, if desired. Additionally, the details area 110 includes a “Parent” button 128 that allows the UX designer to navigate to a parent user interface element to adjust configurable features of that user interface element. Although not shown, if a child user interface element is available, a “Child” button is provided in the details area 110 to allow the UX designer to navigate to the child user interface element to adjust configurable features of that user interface element.

At any point during the design process, the UX designer can select the “Code” button 130 to view the base user interface code that has been generated, or the UX designer can select the “Preview” button 132 to preview the user interface. For instance, FIG. 1I illustrates the base user interface code that is displayed when the “Code” button 130 in selected. The base user interface code shown includes the code generated based on the UX designer's selections, including selected user interface elements and selections made to configurable features of those user interface elements. FIG. 1J illustrates a preview of the user interface when the “Preview” button 132 is selected. In particular, the base user interface code that has been generated is rendered to show the user interface.

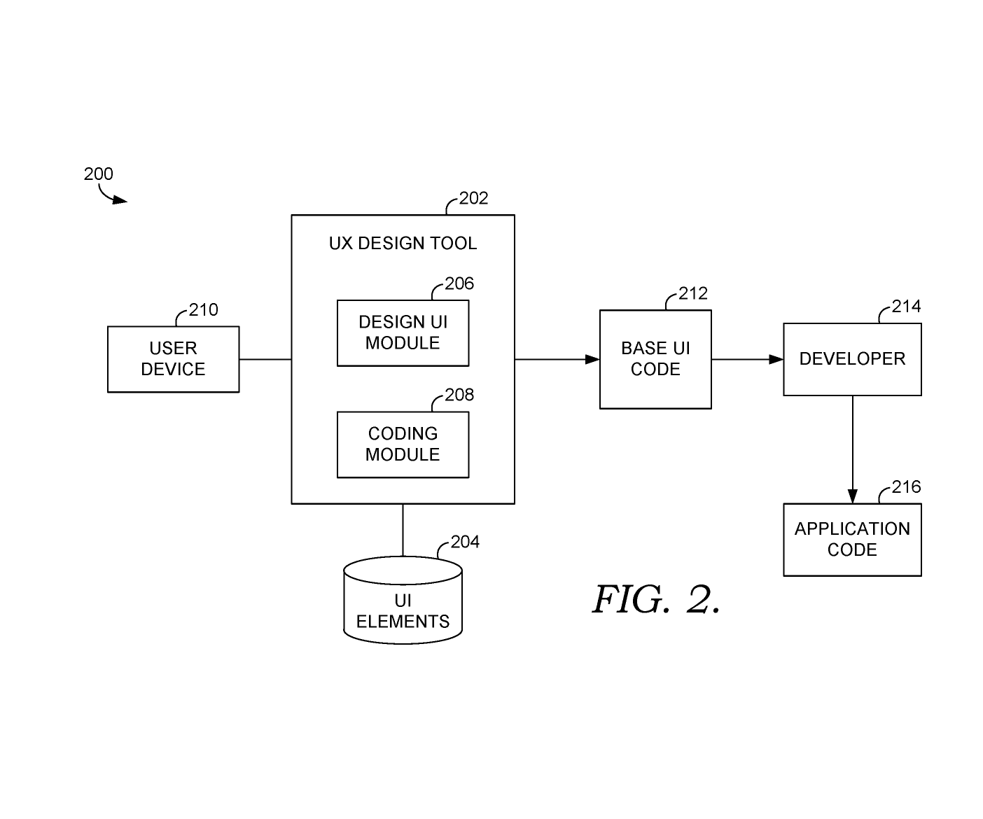

Turning now to FIG. 2, a block diagram is provided illustrating an exemplary system 200 for generating base user interface code in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The system 200 is an example of a suitable architecture for implementing certain aspects of the present disclosure. Among other components not shown, the system 200 includes a UX design tool 202 that facilitates generating base user interface code for developing applications. A number of pre-defined user interface elements 204 are available to the UX design tool 202. Each user interface element comprises pre-defined visible features and configurable features that can be adjusted by a UX designer. Additionally, each user interface element includes underlying code for displaying the visible features of the user interface element configured in accordance with the configurable features. In accordance with some embodiments, the underlying code for each user interface element includes code for adjusting the layout of visible features based on the screen size of the device on which it's rendered. As such, a responsive nature is built into the user interface being designed. This allows for the user interface code to be rendered on different devices and adjust to the screen size (e.g., from large desktop screens to small smartphone screens). In accordance with further embodiments, different versions of the underlying code for each user interface element is provided in different programming languages (e.g., Java, Python, etc.). This allows the UX designer to decide which programming language to use for developing the user interface for an application.

The UX design tool 202 includes a design user interface module 206 that provides a user interface (e.g., as shown in FIGS. 1A-1J) for building an application's user interface in accordance with embodiments herein. For instance, a UX designer may employ a user device 210 to interact with the user interface provided by the design UI module 206. Although the UX design tool 202 is shown separate from the user device 210, it should be understood that the UX design tool 202 may be an application running on the user device 210. Alternatively, the UX design tool 202 can be an application remote from the user device 210, such as an application running on a server accessible to the user device 210 over a network (not shown).

The user interface provided by the design user interface module 206 includes an area for selecting user interface elements and a workspace for building a user interface using the user interface elements. As described above with reference to FIGS. 1A-1J, a UX designer can select user interface elements to add to the workspace. When a user interface element is added to the workspace, visible features of the selected user interface element are presented in the workspace. A coding module 208 updates base user interface code using the underlying code for the selected user interface element. Additionally, a details area is presented with the configurable features for the selected user interface element. If the UX designer adjusts configurable features for the selected user interface element, the visible features in the workspace are updated, and the coding module 208 adjusts the base user interface code based on the adjustments to the configurable features.

In embodiments in which different versions of the underlying code are provided in different programming languages for each user interface element, the design user interface module 206 may present an option to allow the UX designer to select a desired programming language from available programming languages. Based on the UX designer's selection, the underlying code used for selected user interface elements comprises the version in the selected programming language. For instance, if the UX designer selects to use Java, whenever a user interface element is selected and added to the workspace, the underlying Java code for the selected user interface element is used to generate the base user interface code.

When the UX designer is finished configuring a user interface, the UX design tool 202 outputs base user interface code 212, which includes code generated using the underlying code for user interface elements selected by the UX designer with the code adjusted based on selections to configurable features made by the UX designer. The base user interface code 212 is provided to a developer 214 to develop an application. Because the base user interface code comprises actual code that can be used to render a user interface, the base user interface code can be used directly within application code 216 for the application being developed.

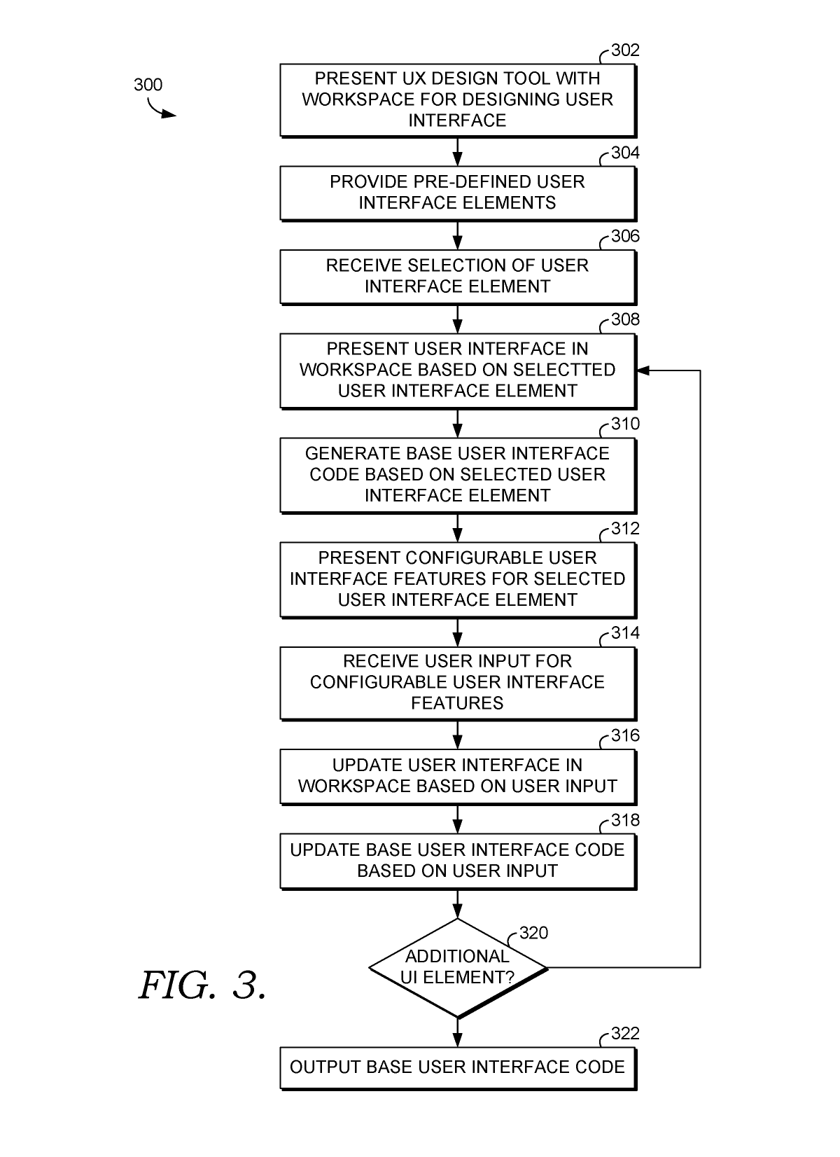

With reference now to FIG. 3, a flow diagram is provided illustrating a method 300 for generating base user interface code that can be used in developing an application. Each block of the method 300 and any other method described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 302, a UX design tool presents a workspace for designing a user interface, such as the workspace 106 in FIGS. 1A-1H. Additionally, pre-defined user interface elements, are provided, as shown at block 304. As discussed previously, each of the pre-defined user interface elements has corresponding code for rendering portions of a user interface.

A user selection of a user interface element is received, at shown at block 306. For instance, as discussed above, to select a user interface element, a user can drag the user interface element from a user interface element area into the workspace. The selected user interface element is presented in the workspace, as shown at block 308. In particular, visible features of the user interface element are presented in the workspace to allow the user to view the features. Base user interface code is generated based on the selected user interface element, as shown at block 310. In particular, the base user interface code comprises the code corresponding with the selected user interface element.

Configurable user interface features for the selected user interface element are also presented, as shown at block 312. For instance, the configurable user interface features could be presented in an area adjacent to the workspace, such as the details area 110 in FIGS. 1B-1H. User input is received for the configurable user interface elements, as shown at block 314. Based on the user input, the visible features of the user interface shown in the workspace are updated, as shown at block 316. Additionally, the base user interface code is updated based on the user input, as shown at block 318. Each user interface element has its own unique set of configurable settings, which range from stylistic adjustment to the content within the user interface element (e.g., bold red text, strikethrough) to higher level layout variations (e.g., long list or grid style view of items). Once the user makes adjustments to the variables provided to them, those changes are reflected in the code—and the code is updated in real-time.

A determination is made at block 320 regarding whether an additional user interface element has been selected. For instance, a user may select another user interface element and add the user interface element to the workspace. If so, the process of blocks 308-318 is repeated. This includes displaying visible features of the newly selected user interface element in the workspace in conjunction with visible features of previously-selected user interface element(s) and updating the base user interface code using the underlying code for the selected user interface element. At least some user interface elements have ‘placeholder’ elements structured within them (e.g., a Detail View user interface element has a drop zone for a Header as well as an allocated space for a Graph to be displayed.). These drop zones represent locations where the user can drag and drop other user interface elements within them. Once a user interface element has been dropped into a ‘placeholder’ drop zone, the code is updated to display the information that the user has chosen to display. Additionally, configurable features of the newly added user interface element are exposed to allow the user to configure those features. When the user is done adding and configuring user interface elements, the base user interface code is output, as shown at block 322. The base user interface code is provided to a developer who uses the base user interface code for user interface features of the application being developed.

Further embodiments of the present invention facilitate the generation of software requirements. Generally, documenting and maintaining software requirements on a per-design basis has traditionally proven to be a time-consuming task. While onerous, it's very important that the functional and user interface requirements are written to a specific level of detail so that the software being released operates and presents itself as intended for both test analysts to approve and even more-so in the event of an audit whereas the minimum application and data requirements must be available. As a byproduct, solution designers (or technical writers) individually document—in written form—every single element in the user interface from top to bottom. At a large scale, this introduces the likelihood that each technical writer documents each element on the screen in a unique fashion (e.g.; “The system shall display a blue button with the text ‘Submit’ versus “The system shall display a button with the color #0000ff and text that reads ‘SAVE”).

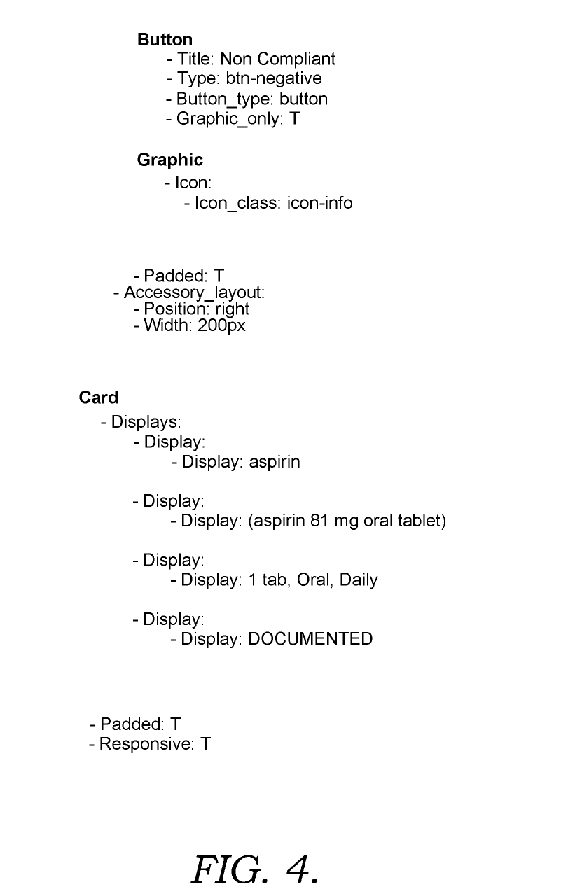

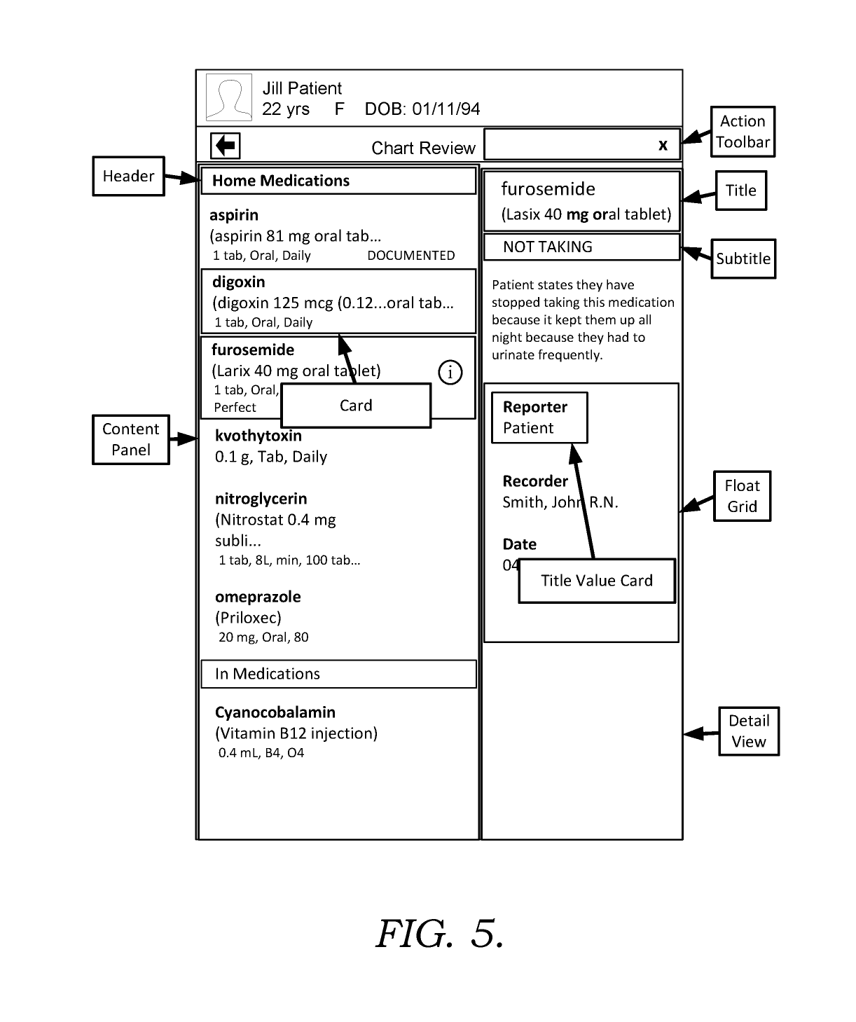

Embodiments of the present invention address this lack of consistency in software requirements. As common, reusable controls are being implemented by the UX designer using the design tool described herein and code is being generated in real-time, the system is able to output requirements in written form which helps streamline the technical documentation effort. At any point in the user's workflow, the technical writer can select to view attributes in the workspace and obtain requirements that are composed based on the elements being referenced in both the design as well as the code. The output is then used to reference UI design patterns at a higher documentation level so that every single screen doesn't need to be documented in such granular fashion. By way of illustration, FIG. 4 provides an example of generated output of requirements. Additionally, FIG. 5 provides an example of documented patterns that are referenced as source material for technical documentation.

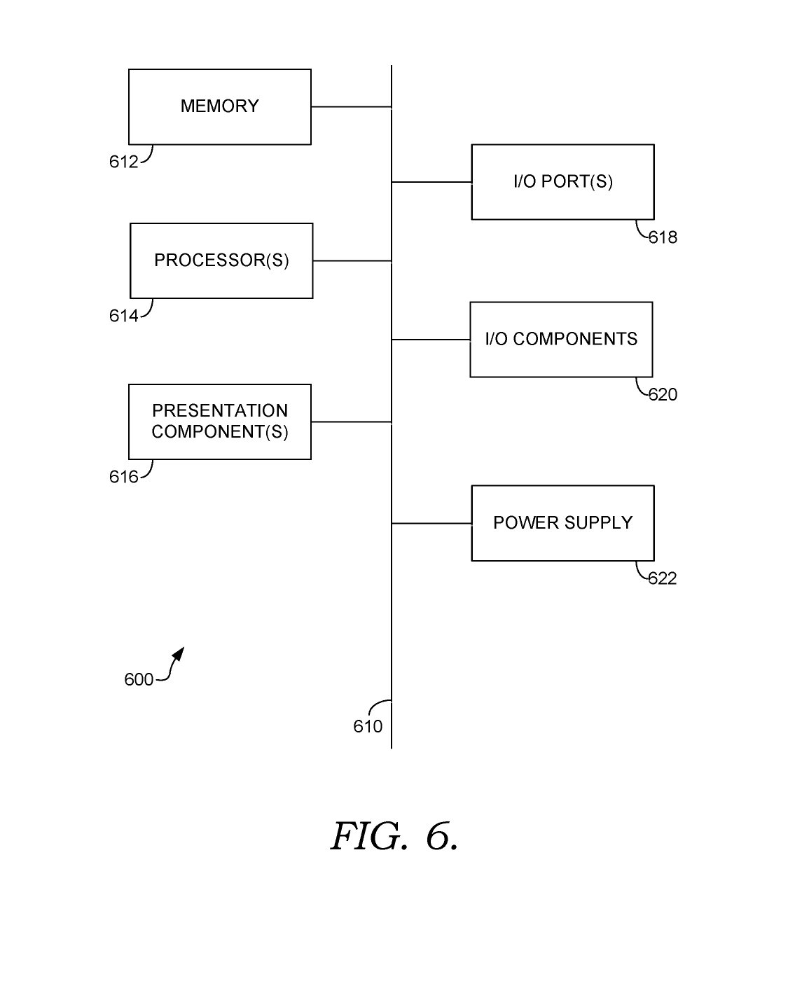

Having described implementations of the present disclosure, an exemplary operating environment in which embodiments of the present invention may be implemented is described below in order to provide a general context for various aspects of the present disclosure. Referring initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes bus 610 that directly or indirectly couples the following devices: memory 612, one or more processors 614, one or more presentation components 616, input/output (I/O) ports 618, input/output components 620, and illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 600. The computing device 600 may be equipped with depth cameras, such as, stereoscopic camera systems, infrared camera systems, RGB camera systems, and combinations of these for gesture detection and recognition. Additionally, the computing device 600 may be equipped with accelerometers or gyroscopes that enable detection of motion.

As described above, implementations of the present disclosure relate to a design tool that facilitates generating user interface code for applications. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when executed by a computing device, cause the computing device to perform operations, the operations comprising:
presenting a workspace for designing a user interface for an application;
providing a plurality of user interface elements, each user interface element comprising one or more visible features and one or more configurable features, each user interface element having corresponding code for rendering the one or more visible features based at least in part on the one or more configurable features;
receiving a selection of a first user interface element;
presenting the one or more visible features of the first user interface element in the workspace;
generating base user interface code from the corresponding code for the first user interface element;
presenting the one or more configurable features for the first user interface element in an area adjacent to the workspace;
in response to receiving user input for the one or more configurable features for the first user interface element, updating the one or more visible features of the first user interface element in the workspace and updating the base user interface code; and
outputting the base user interface code for use in development of the application.

2. The one or more computer storage media of claim 1, wherein the corresponding code for each user interface element includes code for adjusting layout of the visible features based on screen size of a device on which the code is rendered.

3. The one or more computer storage media of claim 1, wherein multiple versions of corresponding code are provided for each user interface element, each version using a different programming language.

4. The one or more computer storage media of claim 3, wherein the operations further comprise:
receiving a selection of a first programming language; and
wherein the base user interface code is generated using a first version of the corresponding code for the selected user interface element in the first programming language.

5. The one or more computer storage media of claim 1, wherein the operations further comprise:
receiving a selection of a second user interface element;
presenting the one or more visible features of the second user interface element in conjunction with the one or more visible features of the first user interface element in the workspace; and
updating the base user interface code from the corresponding code for the second user interface element.

6. The one or more computer storage media of claim 5, wherein the operations further comprise:
presenting the one or more configurable features for the second user interface element in the area adjacent to the workspace; and
in response to receiving user input for the one or more configurable features for the second user interface element, updating the one or more visible features of the second user interface element in the workspace and updating the base user interface code.

7. The one or more computer storage media of claim 1, wherein the operations further comprise:
receiving a user selection to preview the base user interface code; and
in response to the user selection to preview the base user interface code, presenting the base user interface code.

8. The one or more computer storage media of claim 1, wherein the operations further comprise:
receiving a user selection to preview the user interface; and
in response to the user selection to preview the user interface, presenting the user interface by rendering the base user interface code.

9. A computer-implemented method for generating a user interface for an application, the method comprising:
presenting a workspace for designing the user interface for the application;
providing a plurality of user interface elements, each user interface element comprising one or more visible features and one or more configurable features, each user interface element having corresponding code for rendering the one or more visible features based at least in part on the one or more configurable features;
receiving a selection of a first user interface element;
presenting the one or more visible features of the first user interface element in the workspace;
generating base user interface code from the corresponding code for the first user interface element;
presenting the one or more configurable features for the first user interface element in an area adjacent to the workspace;
in response to receiving user input for the one or more configurable features for the first user interface element, updating the one or more visible features of the first user interface element in the workspace and updating the base user interface code; and
outputting the base user interface code for use in development of the application.

10. The method of claim 9, wherein the corresponding code for each user interface element includes code for adjusting layout of the visible features based on screen size of a device on which the code is rendered.

11. The method of claim 9, wherein multiple versions of corresponding code are provided for each user interface element, each version using a different programming language.

12. The method of claim 11, wherein the method further comprises:
receiving a selection of a first programming language; and
wherein the base user interface code is generated using a first version of the corresponding code for the selected user interface element in the first programming language.

13. The method of claim 9, wherein the method further comprises:
receiving a selection of a second user interface element;
presenting the one or more visible features of the second user interface element in conjunction with the one or more visible features of the first user interface element in the workspace; and
updating the base user interface code from the corresponding code for the second user interface element.

14. The method of claim 13, wherein the method further comprises:
presenting the one or more configurable features for the second user interface element in the area adjacent to the workspace; and
in response to receiving user input for the one or more configurable features for the second user interface element, updating the one or more visible features of the second user interface element in the workspace and updating the base user interface code.

15. A computer system comprising:
one or more processors; and
one or more computer storage media storing computer-useable instructions that, when used by the one or more processors, cause the one or more processors to:
present a workspace for designing a user interface for an application;
provide a plurality of user interface elements, each user interface element comprising one or more visible features and one or more configurable features, each user interface element having corresponding code for rendering the one or more visible features based at least in part on the one or more configurable features;
receive a selection of a first user interface element;
present the one or more visible features of the first user interface element in the workspace;
generate base user interface code from the corresponding code for the first user interface element;
present the one or more configurable features for the first user interface element in an area adjacent to the workspace;
in response to receiving user input for the one or more configurable features for the first user interface element, update the one or more visible features of the first user interface element in the workspace and update the base user interface code; and
output the base user interface code for use in development of the application.

16. The system of claim 15, wherein the corresponding code for each user interface element includes code for adjusting layout of the visible features based on screen size of a device on which the code is rendered.

17. The system of claim 15, wherein multiple versions of corresponding code are provided for each user interface element, each version using a different programming language.

18. The system of claim 17, wherein the instructions further cause the one or more processors to:
receive a selection of a first programming language; and
wherein the base user interface code is generated using a first version of the corresponding code for the selected user interface element in the first programming language.

19. The system of claim 15, wherein the instructions further cause the one or more processors to:
receive a selection of a second user interface element;
present the one or more visible features of the second user interface element in conjunction with the one or more visible features of the first user interface element in the workspace; and
update the base user interface code from the corresponding code for the second user interface element.

20. The system of claim 19, wherein the instructions further cause the one or more processors to:
present the one or more configurable features for the second user interface element in the area adjacent to the workspace; and
in response to receiving user input for the one or more configurable features for the second user interface element, update the one or more visible features of the second user interface element in the workspace and update the base user interface code.
